(19) United States
(12) Patent Application Publication
(10) Pub. No.: US 2026/0296915 A1
(43) Pub. Date: Oct. 1, 2026

(54) METHOD FOR REFINING NICKEL SULFATE AT NORMAL PRESSURE AND NICKEL EXTRACTANT USED THEREIN

(71) Applicant: WALSIN LIHWA CORPORATION, Taipei City (TW)

(72) Inventors: Chih-Keng Li, Taipei City (TW); Yu-Hsiang Lo, Taipei City (TW); Yu-Hao Pan, Taipei City (TW)

(73) Assignee: WALSIN LIHWA CORPORATION, Taipei City (TW)

(21) Appl. No.: 19/092,016

(22) Filed: Mar. 27, 2025

(51) Int. Cl. C01G 53/10; C22B 3/44

(52) U.S. Cl. CPC C01G 53/10; C22B 3/44; C01P 2004/60

(57) ABSTRACT

A method for refining nickel sulfate at a normal pressure includes: adding a sulfuric acid solution in high nickel matte powder to form an acid leaching solution; adding a nickel extractant into the acid leaching solution to form an acid leaching extraction solution, wherein the volume ratio of the nickel extractant to the sulfuric acid solution is about 1:1 to 5:1, the nickel extractant includes an acid etching agent, pure water and an auxiliary agent, the acid etching agent accounts for at least 40 wt % of the nickel extractant, the pure water accounts for 50 to 60 wt % of the nickel extractant, and the auxiliary agent is selected from the group consisting of a surfactant, an organic salt and an inorganic salt, and accounts for 0.1 to 10 wt % of the nickel extractant; maintaining an acid leaching extraction reaction for 3 to 10 hours; and filtering out a solid residue.

### BACKGROUND

### Technical Field

The present invention relates to the field of mining and metallurgy, in particular to a method for refining nickel sulfate at a normal pressure and a nickel extractant used therein.

### Related Art

Nickel is a material commonly used in industry, and can be applied to stainless steel, batteries, alloys, antirust electroplating and the like. Currently, the treatment techniques of a mined nickel ore include pyrometallurgical process, and hydrometallurgical process methods such as a pressurized acid leaching method, a normal-pressure acid leaching method, a normal-pressure and high-pressure combined acid leaching method, a reduction roasting ammonia leaching method and the like.

After the nickel ore is processed into high nickel matte (nickel content is greater than 60 wt %), in order to further refine, in the pyrometallurgical process, the high-pressure acid leaching method is generally used, and the high nickel matte is extracted into nickel sulfate and then applied. However, the equipment cost and energy consumption of the high-pressure acid leaching are quite huge. The overall extraction time is about 48 hours, and as for the extraction effect, the nickel content in the nickel sulfate solution is about 68 to 72 wt %.

### SUMMARY

In order to solve the problems in the prior art, a method for refining nickel sulfate at a normal pressure is provided herein. In some examples, the method includes: adding a sulfuric acid solution in a high nickel matte powder to form an acid leaching solution, wherein the concentration of the sulfuric acid solution is at least 25 vol %, the high nickel matte powder contains 60 to 80 wt % of nickel, and the particle size of the high nickel matte powder is 45 to 500 μm; adding a nickel extractant into the acid leaching solution in batches to form an acid leaching extraction solution, and performing an acid leaching extraction reaction on the acid leaching extraction solution, wherein the volume ratio of the nickel extractant to the sulfuric acid solution is about 1:1 to 5:1, the nickel extractant comprises an acid etching agent, pure water and an auxiliary agent, the acid etching agent accounts for at least 40 wt % of the nickel extractant, the pure water accounts for 50 to 60 wt % of the nickel extractant, the auxiliary agent is selected from the group consisting of a surfactant, an organic salt and an inorganic salt, and accounts for 0.1 to 10 wt % of the nickel extractant, and the solid-liquid weight ratio of the high nickel matte powder to the acid leaching extraction solution is 1:1 to 1:15; maintaining the acid leaching extraction reaction for 3 to 10 hours; and filtering out a solid residue in the acid leaching extraction solution to obtain a nickel sulfate-containing filtrate.

In some examples, the surfactant comprises a sulfonate (SO₃⁻), and has the molecular weight of 150 to 300.

In more detail, in some examples, the surfactant is selected from the group consisting of 4-methyl benzenesulfonic acid, dodecane-1-sulfonic acid sodium, 4-aminotoluene-3-sulfonic acid, 2,5-dimethylbenzenesulfonic acid, a 2-naphthol-6-sulfonic acid salt, 4-hydroxybenzenesulfonic acid, sulfanilic potassium acid, sodium 4-vinylbenzenesulfonate, 3-amino-4-hydroxybenzenesulfonic acid, 4-amino-1-naphthalenesulfonic acid, 8-amino-2-naphthalenesulfonic acid, 7-amino-4-hydroxy-2-naphthalenesulfonic acid, a 2-formylbenzenesulfonic acid sodium salt, a 4-amino-1-naphthalenesulfonic acid sodium salt, a benzenethionosulfonic acid sodium salt, a 3-(trimethylsilyl)-1-propanesulfonic acid sodium salt, 3-amino-4-methoxybenzenesulfonic acid, 5-amino-2-naphthalenesulfonic acid and sodium 2-naphthalenesulfonate.

In some examples, the acid etching agent is selected from the group consisting of hydrochloric acid, nitric acid, chromic acid, perchloric acid, hypochlorous acid, citric acid, oxalic acid and acetic acid.

In some examples, the auxiliary agent accounts for 0.5 to 6 wt % of the nickel extractant.

In some examples, the temperature of the acid leaching extraction reaction is maintained at 20 to 60° C., and the pH value is 0.5 to 4.

In some examples, stirring is maintained at a speed of 200 to 800 RPM during the acid leaching extraction reaction.

In some examples, the concentration of the sulfuric acid solution is 30 to 60 vol %.

In some examples, the particle size of the high nickel matte powder is 100 μm to 200 μm.

In some examples, the solid-liquid weight ratio of the high nickel matte powder to the acid leaching extraction solution is 1:4 to 1:6.

In some examples, the organic salt is selected from the group consisting of sodium salts, ammonium salts, aluminum salts, copper salts and iron salts of citric acid, oxalic acid, acetic acid, succinic acid and gluconic acid.

In some examples, the inorganic salt is selected from the group consisting of sodium salts, ammonium salts, aluminum salts, copper salts and iron salts of sulfuric acid, nitric acid, nitrous acid, phosphoric acid and carbonic acid.

In some examples, the method for refining nickel sulfate at a normal pressure further includes neutralizing the nickel sulfate-containing filtrate, adding a precipitant, and filtering out a precipitate; removing an acid etching agent by-product and the surfactant in the nickel sulfate-containing filtrate to obtain a nickel sulfate solution; and removing water in the nickel sulfate solution to obtain a solid nickel sulfate.

Herein, a nickel extractant is further provided. In some examples, the nickel extractant includes an acid etching agent, pure water and an auxiliary agent. The acid etching agent accounts for at least 40 wt %, the pure water accounts for 50 to 60 wt %, and the auxiliary agent is selected from the group consisting of a surfactant, an organic salt and an inorganic salt, and accounts for 0.1 to 10 wt %. In some examples, the acid etching agent is selected from the group consisting of hydrochloric acid, nitric acid, chromic acid, perchloric acid, hypochlorous acid, citric acid, oxalic acid and acetic acid.

In some examples, the surfactant includes a sulfonate (SO₃⁻), and has the molecular weight of 150 to 300.

In more detail, in some examples, the surfactant is selected from the group consisting of 4-methyl benzenesulfonic acid, dodecane-1-sulfonic acid sodium, 4-aminotoluene-3-sulfonic acid, 2,5-dimethylbenzenesulfonic acid, a 2-naphthol-6-sulfonic acid potassium salt, 4-hydroxybenzenesulfonic acid, sulfanilic acid, sodium 4-vinylbenzenesulfonate, 3-amino-4-hydroxybenzenesulfonic acid, 4-amino-1-naphthalenesulfonic acid, 8-amino-2-naphthalenesulfonic acid, 7-amino-4-hydroxy-2-naphthalenesulfonic acid, a 2-formylbenzenesulfonic acid sodium salt, a 4-amino-1-naphthalenesulfonic acid sodium salt, a benzenethionosulfonic acid sodium salt, a 3-(trimethylsilyl)-1-propanesulfonic acid sodium salt, 3-amino-4-methoxybenzenesulfonic acid, 5-amino-2-naphthalenesulfonic acid and sodium 2-naphthalenesulfonate.

In some examples, the auxiliary agent accounts for 0.5 to 6 wt % of the nickel extractant.

In some examples, the organic salt is selected from the group consisting of sodium salts, ammonium salts, aluminum salts, copper salts and iron salts of citric acid, oxalic acid, acetic acid, succinic acid and gluconic acid.

In some examples, the inorganic salt is selected from the group consisting of sodium salts, ammonium salts, aluminum salts, copper salts and iron salts of sulfuric acid, nitric acid, nitrous acid, carbonic acid and phosphoric acid.

As described in the foregoing examples, the high nickel matte may be converted into nickel sulfate at a normal pressure by adding the nickel extractant, thereby greatly reducing the cost of equipment and reaction. Further, the reaction time is greatly shortened, and the nickel content of the solid residue is lower than that of the existing high-pressure acid leaching, such that the leaching rate is more effectively improved, and the capacity is greatly improved.

### BRIEF DESCRIPTION OF THE DRAWINGS

FIG. 1 is a flow diagram of an example of a method for refining nickel sulfate at a normal pressure.

### DETAILED DESCRIPTION

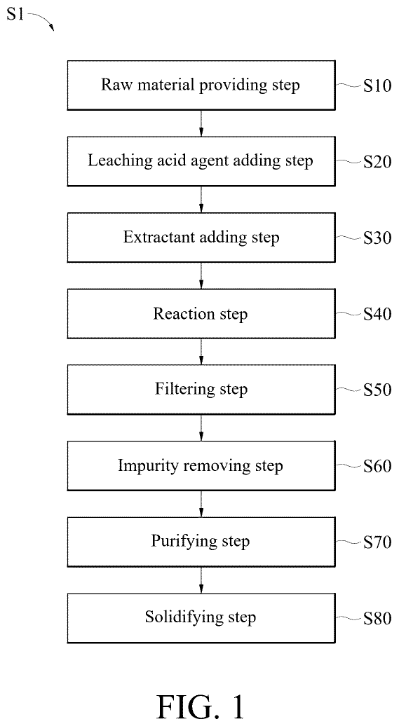

FIG. 1 is a flow diagram of an example of a method for refining nickel sulfate at a normal pressure. As shown in FIG. 1, the method S1 for refining nickel sulfate at a normal pressure includes a raw material providing step S10, a leaching acid agent adding step S20, an extractant adding step S30, a reaction step S40 and a filtering step S50.

In some examples, the raw material providing step S10 is to provide a high nickel matte powder. The high nickel matte powder is obtained by grinding processed high nickel matte ore block particles containing 60-80 wt % of nickel, wherein the particle sizes of the high nickel matte ore block particles are analyzed. As shown in Table 1 below, the particles with the particle sizes of 1 mm or greater account for 70.6%, and the particles with the particle sizes of 500 μm-1 mm account for 23.8%, that is, the particles with the particle sizes of 500 μm or greater account for 97.4%. The average particle size is calculated to 907.01 μm according to the proportion. The particle size of the ground and sieved high nickel matte powder is 500 μm or less, and the particle size mainly falls between 75 μm and 335 μm, totally accounting for 94.95%. The average particle size is calculated to 147.55 μm according to the proportion. Preferably, the particle size of the high nickel matte powder is 75 μm to 335 μm.

TABLE 1

| | Ore block | Powder |
|---|---|---|
| Particle size | particle (%) | (%) |
| 1 mm< | 70.6 | 0 |
| 500 μm-1 mm | 23.8 | 0 |
| 425 μm-500 μm | 2.5 | 0.5 |
| 335 μm-425 μm | 2.5 | 1.5 |
| 180 μm-335 μm | 0.4 | 7.54 |
| 100 μm-180 μm | 0.3 | 84.4 |
| 75 μm-100 μm | 0 | 3.01 |
| 45 μm-75 μm | 0 | 1.8 |
| <45 μm | 0 | 1.25 |
| Average | 907.01 | 147.55 |

In some examples, the leaching acid agent adding step S20 is that a sulfuric acid solution is added in the high nickel matte powder to form an acid leaching solution, and after the leaching acid agent adding step S20, the high nickel matte powder begins to react with the sulfuric acid, wherein the concentration of the sulfuric acid solution is at least 25 vol %. Preferably, the concentration of the sulfuric acid solution is 30 to 60 vol %, for example, 50 vol %.

The extractant adding step S30 is that a nickel extractant is added into the acid leaching solution in batches, for example, is added once every other 5, 10 and 15 minutes. Thus, an acid leaching extraction solution is formed, and an acid leaching extraction reaction is performed in the acid leaching extraction solution. Here, the volume ratio of the nickel extractant to the sulfuric acid solution is about 1:1 to 5:1, and the addition amount of each time may be adjusted according to the actual ratio. Here, the nickel extractant includes an acid etching agent, pure water and an auxiliary agent. The acid etching agent accounts for at least 40 wt % of the nickel extractant, the pure water accounts for 50 to 60 wt % of the nickel extractant, and the auxiliary agent may be a surfactant, an organic salt and an inorganic salt, or a combination thereof, and accounts for 0.1 to 10 wt % of the nickel extractant. Preferably, the auxiliary agent accounts for 0.5 to 6 wt % of the nickel extractant. Here, the solid-to-liquid ratio (g/ml, i.e. the volume of the acid leaching extraction solution per g of the high nickel matte powder) of the high nickel matte powder to the acid leaching extraction solution is 1:1 to 1:15. When the solid-to-liquid ratio is 1:4, the nickel leaching rate reaches 95%. When the solid-to-liquid ratio is 1:6 or more acid leaching extraction solutions are added, the nickel leaching rate reaches 99% or greater. The slight difference mainly comes from the influence of filtration, other reaction conditions or experimental environment. Preferably, the weight ratio of the high nickel matte powder to the acid leaching extraction solution is 1:4 to 1:6.

In addition, in order to maintain the speed of the acid leaching extraction reaction, the temperature of the acid leaching extraction reaction is maintained in the range of 20 to 60° C., and preferably, is controlled in the range of 45-55° C. In addition, when the sulfuric acid and the nickel extractant are added, the pH is controlled in the range of 0.5 to 4, preferably 0.75 to 3.8.

The acid etching agent in the nickel extractant is one or a combination of more of hydrochloric acid, nitric acid, chromic acid, chromates, permanganates, perchloric acid, hypochlorous acid, citric acid, oxalic acid, acetic acid and the like. Since the pH value of reaction conditions is controlled to enable the environment to be acidic, the acid etching agent capable of being dissociated to generate hydrogen ions in an aqueous solution is preferred. The acid etching agent with strong oxidative strength may assist the sulfuric acid to react with the nickel matte raw material, such as the hydrochloric acid, the nitric acid, the chromic acid, the chromates, the permanganates, the perchloric acid, the hypochlorous acid and the like, but anionic groups of the acid etching agent with the weak oxidative strength, such as citric acid, oxalic acid and acetic acid may be chelated with oxidized metal ions, thereby enhancing the effect of the auxiliary agent. The auxiliary agent is used to assist oxidized Ni²⁺ ions to leave the surfaces of the high nickel matte particles as soon as possible to accelerate the reaction, which may be assisted by the surfactant, the organic salt, or the inorganic salt, or a combination thereof. The surfactant may reduce the surface tension and increase the contact area between the sulfuric acid solution and the nickel extractant and the surface of the high nickel matte powder. In addition, the surfactant is dissociated in the solution, for example, a sulfonate anion forms a negatively charged hydrophilic end, which may attract a reacted metal cation. Therefore, the dispersibility of an ionic compound in the solution is increased, the ionic compound after the acid leaching extraction reaction is prevented from aggregating on the surface of the high nickel matte powder, the ionic compound may be brought away from the surface of the high nickel matte powder, and the ionic compound is prevented from aggregating to reduce the rate of the acid leaching extraction reaction.

In more detail, the surfactant includes a sulfonate (SO₃⁻), and has the molecular weight of 150 to 300. In more detail, the surfactant may be one or more of 4-methyl benzenesulfonic acid, dodecane-1-sulfonic acid sodium, 4-aminotoluene-3-sulfonic acid, 2,5-dimethylbenzenesulfonic acid, a 2-naphthol-6-sulfonic acid potassium salt, 4-hydroxybenzenesulfonic acid, sulfanilic acid, sodium 4-vinylbenzenesulfonate, 3-amino-4-hydroxybenzenesulfonic acid, 4-amino-1-naphthalenesulfonic acid, 8-amino-2-naphthalenesulfonic acid, 7-amino-4-hydroxy-2-naphthalenesulfonic acid, a 2-formylbenzenesulfonic acid sodium salt, a 4-amino-1-naphthalenesulfonic acid sodium salt, a benzenethionosulfonic acid sodium salt, a 3-(trimethylsilyl)-1-propanesulfonic acid sodium salt, 3-amino-4-methoxybenzenesulfonic acid, 5-amino-2-naphthalenesulfonic acid and sodium 2-naphthalenesulfonate.

In addition, the organic salt is dissociated in the solution and may be temporarily combined with Ni²⁺ ions as a chelating agent, thereby improving the overall nickel leaching rate. Here, the organic salt may be sodium salts, ammonium salts, aluminum salts, copper salts and iron salts of citric acid, oxalic acid, acetic acid, succinic acid and gluconic acid. Preferably, the organic salt is one or more selected from sodium dihydrogen citrate, ammonium ferric citrate, ammonium citrate, copper citrate, sodium oxalate, sodium hydrogen oxalate, ammonium ferric oxalate, sodium acetate, sodium diacetate, aluminum triacetate, copper acetate, ammonium acetate, sodium succinate, copper succinate, ammonium succinate, sodium gluconate, copper gluconate and aluminum gluconate.

The inorganic salt may be sodium salts, ammonium salts, aluminum salts, copper salts and iron salts of sulfuric acid, nitric acid, nitrous acid, phosphoric acid and carbonic acid, such as one or more of sodium nitrate, copper nitrate, ferrous nitrate, ferric nitrate, ammonium nitrate, sodium carbonate, ferric carbonate, ammonium carbonate, sodium sulfate, aluminum sulfate, copper sulfate, cuprous sulfate, ferric sulfate, ferrous sulfate, ammonium sulfate, diammonium phosphate, monoammonium phosphate and sodium phosphate. Generally, the inorganic salt may be dissolved in water or an acid to be fully dissociated, exhibits the oxidative strength in the solution to promote the oxidation of high nickel matte into nickel ions, which results in improving the nickel leaching rate. In addition, while performing an oxidation reaction together with the acid etching agent, the cation is hydrolyzed to enable the pH value of the solution to be acidic and close to neutral, thereby further reducing the cost of the subsequent treatment steps.

The reaction step S40 is that after the leaching acid agent adding step S20 and the extractant adding step S30, the acid leaching extraction reaction is continuously maintained for 3 to 10 hours. Preferably, the acid leaching extraction reaction is performed for 4 to 8 hours. In addition, in order to maintain the speed of the acid leaching extraction reaction, a stirrer or a magnetic stirring rod may be used for maintaining stirring at a stirring speed of 200-350 RPM during the acid leaching extraction reaction.

The filtering step S50 is that after the acid leaching extraction reaction time is reached, the solid residue in the acid leaching extraction solution is filtered out, so as to obtain the nickel sulfate-containing filtrate. In order to prevent the ionic compound obtained by the reaction remaining on the surface of the solid residue, the solid residue may be soaked, rinsed, distilled, etc. with a solvent. The solvent in which the ionic compound obtained by the reaction is dissolved is added to the nickel sulfate-containing filtrate for the subsequent steps.

Further, the method S1 for refining nickel sulfate at a normal pressure further includes an impurity removing step S60, a purifying step S70 and a solidifying step S80. The impurity removing step S60 is that the nickel sulfate-containing filtrate is first neutralized, a precipitant is added for other metal materials such as cobalt, manganese, calcium, iron, magnesium, silicon and the like in the high nickel matte powder, and a generated precipitate is filtered out. Therefore, the concentration of nickel ions in the nickel sulfate-containing filtrate may be improved.

The purifying step S70 is that the acid etching agent by-product and the surfactant are removed from the nickel sulfate-containing filtrate, for example, by adding an ammonium salt or by a distillation method, so as to obtain a nickel sulfate solution. The solidifying step S80 is that a solid nickel sulfate is obtained by crystallization or heating to remove water from the nickel sulfate solution. By analyzing the nickel contents of the finally obtained solid nickel sulfate and initial high nickel matte powder, a leaching rate of 70% or greater, even up to 98%, may be at least obtained. Therefore, the method has the same degree as the current pressurized acid leaching method and even better effect.

When the organic salt or the inorganic salt is added to the auxiliary agent, the pH value may also be adjusted in addition to improving the oxidative strength. A part of the organic salt or the inorganic salt may increase the pH value, reduce the neutralizing cost in the impurity removing step S60, or accelerate the precipitation of other cations in the purifying step S70, thereby improving the overall reaction rate and reducing the cost of the steps.

Actual experiments may be provided below to illustrate the actual operations of the method S1 for refining nickel sulfate at a normal pressure.

### Experiment 1

Experiment 1 was performed with a small number of samples to present that the method S1 for refining nickel sulfate at a normal pressure was substantially feasible. Here, the leaching rate was mainly considered, and the nickel sulfate-containing filtrate obtained after a filtering step S50 was sampled and analyzed for determination. Subsequent impurity removing step S60, purifying step S70 and solidifying step S80 were omitted. Only the nickel sulfate-containing filtrate was used for determining leaching.

First, a raw material providing step S10 was that a high nickel matte ore material was first ground into powder and screened to the particle size ranging from 75 μm to 335 μm. The high nickel matte powder was sampled. The main compositions of this batch of the high nickel matte powder were analyzed by an ICP and shown in Table 2 below. A leaching acid agent adding step S20 was that 10 g of the high nickel matte powder was taken, added into 20 ml of 50% sulfuric acid and heated to 50° C., the pH of the prepared solution was about 1, the temperature was maintained, and stirring was performed by using a magnetic stirring rod at a stirring speed kept at 300 rpm.

Here, an extractant adding step S30 was that 20 ml of pure nitric acid, hydrochloric acid or hydrogen peroxide was used as an acid etching agent, 80 ml of pure water was added, and 1 wt % of 4-methyl benzenesulfonic acid (atomic weight of 190.22) was added to be prepared into a nickel extractant. Then, 5 ml of the extractant was added in batches to an acid leaching solution once every other 15 minutes, finally obtaining a total of 200 ml of the final acid leaching extraction solution. Then the full reaction was maintained for 8 hours. Then, the filtering step S50 was performed to filter out a solid residue in the acid leaching extraction solution, the solid residue was washed with an appropriate amount of pure water to obtain a nickel sulfate-containing filtrate, and a sample was taken for analysis. The analysis of metal ions was shown in Table 3, wherein the proportion of nickel ions of the nickel sulfate-containing filtrate was greater than 90 g/L. Referring to the standard of the pressurized acid leaching method, the leaching rate of nickel was calculated to be about 68.6%, which was equivalent to the leaching rate of the current pressurized acid leaching method, and had economic feasibility.

Here, when different acid etching agents were used, different leaching rates of nickel were also obtained. However, the leaching rate was higher than that of the current pressurized acid leaching method regardless of the hydrochloric acid, the nitric acid or the hydrogen peroxide. In more detail, the nitric acid had a slightly higher leaching rate as an acid etching agent than the hydrochloric acid and the hydrogen peroxide and may be blended by considering the actual cost.

TABLE 2

| Composition | Ni | Fe | Co | Cr | Mg | Si | Ca | Cu | Al | S |
|---|---|---|---|---|---|---|---|---|---|---|
| wt % | 78.7 | 3.2 | 1.19 | <1 ppm | 0.013 | 0.233 | <1 ppm | 0.222 | <1 ppm | 15.3 |

TABLE 3

| Concentration | Ni | Fe | Co | Mg | Si | Cu | Al |
|---|---|---|---|---|---|---|---|
| g/L | 90.00 | 5.09 | 1.28 | 0.60 | 0.34 | 0.05 | 0.39 |
| Reference | >90 | <0.01 | >2 | <0.02 | <0.03 | <0.02 | <0.02 |
| standard (g/L) | | | | | | | |

### Experiment 2

In experiment 2, whether the nickel extractant was added was used for comparison. Here, all leaching acid agents were 120 ml of 50 vol % sulfuric acid blended with 80 ml of pure water. The experimental conditions were reaction temperature of 50° C., reaction time of 4 hours, pH maintained at 1 and stirring speed kept at 300 rpm. The compositions of the nickel extractant were the same as those in experiment 1.

Here, the sample material of experimental example 1 was 15 g of high nickel matte powder. Through an ICP analysis, the nickel content was 62.80 wt % and the weight of nickel was calculated to be 9.416 g. The sample material of comparative example was 15.056 g of high nickel matte. Through the ICP analysis, the nickel content was 60.80 wt % and the weight of the nickel was calculated to be 9.152 g. Experimental example 1 and the comparative example were compared as shown in Table 4 below.

TABLE 4

| | | Experimental | Comparative |
|---|---|---|---|
| | | example 1 | example |
| Raw material | Sampling weight | 15 | 15.056 |
| | Nickel-containing | 62.8 | 60.8 |
| | proportion (wt %) | | |
| | Nickel-containing | 9.416 | 9.152 |
| | weight (g) | | |
| Nickel | Total volume (ml) | 235.2 | 188 |
| sulfate- | Nickel content (g/L) | 37.1 | 32 |
| containing | Nickel-containing | 8.728 | 6.016 |
| filtrate | weight (g) | | |
| Solid residue | Solid weight (g) | 2.504 | 8.856 |
| | Nickel-containing | 27.4 | 35.4 |
| | proportion (wt %) | | |
| | Nickel-containing | 0.688 | 3.136 |
| | weight (g) | | |
| | Nickel recovery rate | 92.7 | 65.7 |
| | (%) | | |
| | Residue rate (%) | 16.78% | 58.82% |

It can be seen from Table 4 that under the same conditions, by adding the nickel extractant and adjusting the appropriate solid-to-liquid ratio, the nickel recovery rate exceeding 90% may be obtained. However, in the comparative example without adding the nickel extractant, the nickel content in the filtrate was similar to that in the pressurized acid leaching method. But the solid residue was heavier and the nickel content in the solid residue was higher.

### Experiment 3

In experiment 3, the leaching effects under different solid-to-liquid ratios were considered. The other conditions of the experiment were the same as those of experiments 1 and 2. The reaction temperature was 50° C., the reaction time was 4 hours, the pH was maintained at 1 and the stirring speed was kept at 300 rpm. In experimental examples 2 and 3, the solid-to-10 liquid ratios were 1:2 and 1:4 respectively. In experimental examples 4-7, the solid-to-liquid ratios were 1:6. The high nickel matte powder used was the same batch and the nickel content was 75.14 wt %. The results were shown in Table 5 below.

TABLE 5

| | | Weight of high | Weight of | Nickel | |
|---|---|---|---|---|---|
| | Solid-to- | nickel matte | solid residue | content of | Nickel |
| | liquid ratio | powder (g) | (g) | solid residue | leaching rate |
| Experimental | 1:2 | 9.638 | 4.6569 | 46.17 wt % | 70.3% |
| example 2 | | | | | |
| Experimental | 1:4 | 9.6596 | 1.1052 | 31.58 wt % | 95.2% |
| example 3 | | | | | |
| Experimental | 1:6 | 10.000 | 0.4843 | 4.51 wt % | 99.7% |
| example 4 | | | | | |
| Experimental | 1:6 | 10.000 | 0.5487 | 5.54 wt % | 99.6% |
| example 5 | | | | | |
| Experimental | 1:6 | 9.9409 | 0.6458 | 10.61 wt % | 99.1% |
| example 6 | | | | | |
| Experimental | 1:6 | 10.064 | 0.6796 | 13.96 wt % | 98.8% |
| example 7 | | | | | |

### Experiment 4

Experiment 4 was performed based on the results of experiment 3 and further based on different solid-to-liquid ratios. The results were shown in Table 6 below.

TABLE 6

| | High nickel | Acid leaching | | Nickel leaching |
|---|---|---|---|---|
| | matte powder | extraction | Solid-to-liquid | rate |
| | (g) | solution (ml) | ratio (g/ml) | (%) |
| Experimental | 10 | 10 | 1:1 | 60.5 |
| example 8 | | | | |
| Experimental | 10 | 15 | 1:1.5 | 62.9 |
| example 9 | | | | |
| Experimental | 10 | 20 | 1:2 | 70.3 |
| example 10 | | | | |
| Experimental | 10 | 25 | 1:2.5 | 75.8 |
| example 11 | | | | |
| Experimental | 10 | 30 | 1:3 | 85.3 |
| example 12 | | | | |
| Experimental | 10 | 20 | 1:2 | 72.5 |
| example 13 | | | | |
| Experimental | 10 | 30 | 1:3 | 82.1 |
| example 14 | | | | |
| Experimental | 10 | 40 | 1:4 | 95.2 |
| example 15 | | | | |
| Experimental | 10 | 50 | 1:5 | 99.0 |
| example 16 | | | | |
| Experimental | 10 | 60 | 1:6 | 98.8 |
| example 17 | | | | |
| Experimental | 10 | 40 | 1:4 | 96.6 |
| example 18 | | | | |
| Experimental | 10 | 60 | 1:6 | 99.6 |
| example 19 | | | | |
| Experimental | 10 | 80 | 1:8 | 99.5 |
| example 20 | | | | |
| Experimental | 10 | 100 | 1:10 | 99.4 |
| example 21 | | | | |
| Experimental | 10 | 120 | 1:12 | 99.2 |
| example 22 | | | | |
| Experimental | 10 | 50 | 1:5 | 97.3 |
| example 23 | | | | |
| Experimental | 10 | 75 | 1:7.5 | 98.9 |
| example 24 | | | | |
| Experimental | 10 | 100 | 1:10 | 99.2 |
| example 25 | | | | |
| Experimental | 10 | 125 | 1:12.5 | 99.6 |
| example 26 | | | | |
| Experimental | 10 | 150 | 1:15 | 99.5 |
| example 27 | | | | |

The blending results of experimental examples 2, 8 and 9 may be seen from Tables 5 and 6. The effects were close to the leaching rate of the pressurized acid leaching method. The result of an average leaching rate of experiments 4-7 was 99.3%. As shown in experimental examples 3 to 7 and experimental examples 15 to 27, when the solid-to-liquid ratio was greater than 1:4, the leaching rate was greater than 90% and the leaching effect and leaching efficiency were good.

### Experiment 5

Experiment 5 was performed for different particle sizes and stirring. Table 7 showed the experimental conditions of experimental examples 28, 29 and 30, in which the solid-to-liquid ratio was fixed at 1:10. Table 8 showed the analysis of the experimental results of experimental example 28, 29 and 30. Tables 9, 10 and 11 showed the composition ratios of samples taken at different reaction times for experimental example 28, 29 and 30 respectively.

TABLE 7

| | | Average | | | | |
|---|---|---|---|---|---|---|
| | | particle size | Reaction | Reaction | | Stirring |
| | Weight of | of powder | temperature | time | Final pH | speed |
| | powder (g) | (μm) | (° C.) | (HR) | value | (RPM) |
| Experimental | 20 | 147 | 50 | 4 | 0.52 | 300 |
| example 28 | | | | | | |
| Experimental | 20 | 907 | | | 0.38 | 300 |
| example 29 | | | | | | |
| Experimental | 50 | 147 | | | 0.70 | 250 |
| example 30 | | | | | | |

TABLE 8

| | Weight of | Nickel- | Solid | Nickel-containing | Nickel |
|---|---|---|---|---|---|
| | powder | containing | residue | proportion of solid | leaching |
| | (g) | proportion | (g) | residue | rate |
| Experimental | 20 | 66.63 wt % | 2.8 | 20.17 wt % | 96% |
| example 28 | | | | | |
| Experimental | 20 | | 7.1 | 27.45 wt % | 85% |
| example 29 | | | | | |
| Experimental | 50 | | 7.3 | 21.55 wt % | 95% |
| example 30 | | | | | |

TABLE 9

| | Experimental example 28 | | | | | | | | | | | |
|---|---|---|---|---|---|---|---|---|---|---|---|---|
| | wt % | | | ppm | | | | | | | | |
| | Elementary composition | | | | | | | | | | | |
| | Ni | Co | Mn | Ca | Cr | Cu | Fe | Al | Mg | Si | Na | S |
| Raw material | 66.63 | 1.24 | 0.00 | 7,930 | 140 | 560 | 96,243 | 26 | 2,094 | 1,068 | 1,942 | 107,323 |
| 1 HR | 2.95 | 0.04 | 0.00 | 0 | 0 | 32 | 6,410 | 0 | 0 | 0 | 0 | 136,156 |
| sampling | | | | | | | | | | | | |
| 2 HR | 4.17 | 0.06 | 0.00 | 0 | 0 | 42 | 7,167 | 0 | 0 | 0 | 0 | 127,330 |
| sampling | | | | | | | | | | | | |
| 3 HR | 4.58 | 0.07 | 0.00 | 0 | 0 | 41 | 6,989 | 0 | 0 | 0 | 0 | 103,948 |
| sampling | | | | | | | | | | | | |
| 4 HR | 3.44 | 0.05 | 0.00 | 0 | 0 | 31 | 5,387 | 0 | 0 | 0 | 0 | 74,489 |
| sampling | | | | | | | | | | | | |
| Solid residue | 20.17 | 0.45 | 0.00 | 21,118 | 75 | 308 | 87,907 | 109 | 5,588 | 85 | 3,538 | 128,336 |

TABLE 10

| | Experimental example 29 | | | | | | | | | | | |
|---|---|---|---|---|---|---|---|---|---|---|---|---|
| | wt % | | | ppm | | | | | | | | |
| | Elementary composition | | | | | | | | | | | |
| | Ni | Co | Mn | Ca | Cr | Cu | Fe | Al | Mg | Si | Na | S |
| Raw material | 66.63 | 1.24 | 0.00 | 7,930 | 140 | 560 | 96,243 | 26 | 2,094 | 1,068 | 1,942 | 107,323 |
| 1 HR | 2.11 | 0.03 | 0.00 | 0 | 0 | 20 | 3,044 | 0 | 0 | 0 | 0 | 137,464 |
| sampling | | | | | | | | | | | | |
| 2 HR | 2.92 | 0.05 | 0.00 | 0 | 0 | 27 | 4,581 | 0 | 0 | 0 | 0 | 125,230 |
| sampling | | | | | | | | | | | | |
| 3 HR | 3.20 | 0.05 | 0.00 | 0 | 0 | 30 | 4,905 | 0 | 0 | 0 | 0 | 104,650 |
| sampling | | | | | | | | | | | | |
| 4 HR | 2.03 | 0.03 | 0.00 | 0 | 0 | 17 | 2,731 | 0 | 0 | 0 | 0 | 48,032 |
| sampling | | | | | | | | | | | | |
| Solid residue | 27.45 | 0.68 | 0.00 | 19,731 | 77 | 447 | 95,132 | 38 | 4,832 | 150 | 3,285 | 61,909 |

TABLE 11

| | Experimental example 30 | | | | | | | | | | | |
|---|---|---|---|---|---|---|---|---|---|---|---|---|
| | wt % | | | ppm | | | | | | | | |
| | Elementary composition | | | | | | | | | | | |
| | Ni | Co | Mn | Ca | Cr | Cu | Fe | Al | Mg | Si | Na | S |
| Raw material | 66.63 | 1.24 | 0.00 | 7,930 | 140 | 560 | 96,243 | 26 | 2,094 | 1,068 | 1,942 | 107,323 |
| 1 HR | 3.59 | 0.05 | 0.00 | 0 | 0 | 35 | 8,665 | 0 | 0 | 0 | 0 | 133,488 |
| sampling | | | | | | | | | | | | |
| 2 HR | 4.25 | 0.06 | 0.00 | 0 | 0 | 48 | 9,078 | 0 | 0 | 0 | 0 | 120,514 |
| sampling | | | | | | | | | | | | |
| 3 HR | 4.11 | 0.05 | 0.00 | 0 | 0 | 50 | 9,494 | 0 | 0 | 0 | 0 | 111,110 |
| sampling | | | | | | | | | | | | |
| 4 HR | 4.17 | 0.06 | 0.00 | 0 | 0 | 37 | 6,700 | 0 | 0 | 0 | 0 | 79,784 |
| sampling | | | | | | | | | | | | |
| Solid residue | 21.55 | 0.59 | 0.00 | 21,022 | 10 | 400 | 57,150 | 35 | 5,377 | 85 | 3,391 | 166,224 |

It can be seen from Tables 7 to 11 that the particle sizes of the powders were relatively small in experimental examples 28 and 30. The leaching rates were relatively great due to the large reaction contact areas. Increasing the stirring speed may slightly increase the leaching effect. But overall, the effect of the particle size was relatively great. The oxidation reaction time of the whole nickel extraction solution was about 3 to 4 hours and the peak of the reaction may be reached.

### Experiment 6

Experiment 6 discussed the effects of different auxiliary agents on the leaching rate. Table 12 was a discussion of the effects caused the different auxiliary agents aiming at different experimental examples. Here, the experimental conditions of experiment 6 were that 10 g of the high nickel matte powder, 120 ml of 50 vol % sulfuric acid and 80 ml of pure water were used as an acid leaching solution, 20 mL of 10 wt % nitric acid, hydrochloric acid, perchloric acid, hypochlorous acid, citric acid, oxalic acid and acetic acid and 80 mL of pure water were used an acid etching agent, and the concentration was 1 wt %. The experimental conditions were reaction temperature of 50° C., reaction time of 4 hours and stirring speed kept at 300 rpm. In the comparative example and experimental examples 31 and 37 to 41, the nitric acid was used as the acid etching agent. In experimental examples 32 to 34, citric acid was used as the acid etching agent. In examples 35 and 36, acetic acid was used as the acid etching agent. In experimental examples 42 to 43, oxalic acid was used as the acid etching agent. Basically, an acid used in the acid etching agent was the same as or similar to, after dissociation, an acid radical of an organic salt/inorganic salt of the auxiliary agent.

TABLE 12

| | | | | | | Acid leaching | |
|---|---|---|---|---|---|---|---|
| | | | | | | process | |
| | Auxiliary agent | | | | | Nickel | |
| | | Addition | | Organic salt/ | Addition | leaching | pH |
| No. | Surfactant | amount | | inorganic salt | amount | rate (%) | value |
| Comparative | None | — | | None | — | 65.7 | 1.2 |
| example | | | | | | | |
| Experimental | 4-methyl | 1 | wt % | None | — | 92.7 | 1 |
| example 31 | benzenesulfonic acid | | | | | | |
| Experimental | 4-methyl | 1 | wt % | Sodium | 4 wt % | 92.6 | 0.8 |
| example 32 | benzenesulfonic acid | | | dihydrogen | | | |
| | | | | citrate | | | |
| Experimental | 4-methyl | 1 | wt % | Ammonium | 4 wt % | 97.2 | 1.1 |
| example 33 | benzenesulfonic acid | | | ferric citrate | | | |
| Experimental | 4-methyl | 1 | wt % | Ammonium | 5 wt % | 96.7 | 0.8 |
| example 34 | benzenesulfonic acid | | | citrate | | | |
| Experimental | 4-methyl | 1 | wt % | Sodium | 4 wt % | 93.1 | 1.7 |
| example 35 | benzenesulfonic acid | | | diacetate | | | |
| Experimental | 4-methyl | 1 | wt % | Copper acetate | 4 wt % | 97.1 | 1 |
| example 36 | benzenesulfonic acid | | | | | | |
| Experimental | Dodecane-1-sulfonic | 0.8 | wt % | Sodium nitrate | 3 wt % | 97.1 | 2.1 |
| example 37 | acid sodium | | | | | | |
| Experimental | Dodecane-1-sulfonic | 0.8 | wt % | Copper nitrate | 4 wt % | 96.8 | 1.8 |
| example 38 | acid sodium | | | | | | |
| Experimental | Dodecane-1-sulfonic | 0.8 | wt % | Ferric nitrate | 4 wt % | 93.4 | 1.2 |
| example 39 | acid sodium | | | | | | |
| Experimental | Dodecane-1-sulfonic | 0.8 | wt % | Ferrous nitrate | 4 wt % | 95.7 | 1.4 |
| example 40 | acid sodium | | | | | | |
| Experimental | Dodecane-1-sulfonic | 0.8 | wt % | Ammonium | 5 wt % | 98.2 | 0.8 |
| example 41 | acid sodium | | | nitrate | | | |
| Experimental | 4-Aminotoluene-3- | 1 | wt % | Sodium | 3 wt % | 98.6 | 3.7 |
| example 42 | sulfonic acid | | | carbonate | | | |
| Experimental | 4-Aminotoluene-3- | 1 | wt % | Ferric carbonate | 4 wt % | 96.2 | 0.9 |
| example 43 | sulfonic acid | | | | | | |

Here, in each example of experiment 6, the examples with the auxiliary agents may achieve the effects of increasing the nickel leaching rate. The nickel leaching rates all exceeded 92% and were much greater than that of the comparative example without the auxiliary agent. In addition, in the examples in which the organic salt or the inorganic salt was added, most leaching rates of nickel were greater than those in the experimental examples in which only the surfactant was added. In addition, the pH value of the added inorganic salt was often relatively great, thereby further reducing the neutralization cost in a subsequent impurity removing step S60. However, the experiments were only for proving feasibility, and only used for illustration and not for limitation.

In summary, the present disclosure may perform the acid leaching extraction reaction of converting the high nickel matte into nickel sulfate at a normal pressure by adding the nickel extractant, thereby greatly reducing the cost of the equipment and the reaction. Further, compared with 48 hours of the pressurized acid leaching method, the time of the acid leaching extraction reaction only needed 3 to 10 hours and the reaction time was greatly shortened. In addition, the weight of the solid residue and the nickel content in the solid residue were all lower than those of the current pressurized acid leaching method, indicating the method more effectively increased the reaction, improved the leaching rate, and greatly improving the capacity and the leaching efficiency.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for refining nickel sulfate at a normal pressure, comprising:
adding a sulfuric acid solution in a plurality of high nickel matte powders to form an acid leaching solution, wherein the concentration of the sulfuric acid solution is at least 25 vol %, the high nickel matte powders contain 60-80 wt % of nickel, and the particle sizes of the high nickel matte powders are 45 to 500 μm;
adding a nickel extractant into the acid leaching solution in batches to form an acid leaching extraction solution, and performing an acid leaching extraction reaction on the acid leaching extraction solution, wherein the volume ratio of the nickel extractant to the sulfuric acid solution is about 1:1 to 5:1, the nickel extractant comprises an acid etching agent, pure water and an auxiliary agent, the acid etching agent accounts for at least 40 wt % of the nickel extractant, the pure water accounts for 50 to 60 wt % of the nickel extractant, the auxiliary agent is selected from the group consisting of a surfactant, an organic salt and an inorganic salt, and accounts for 0.1 to 10 wt % of the nickel extractant, and the solid-liquid weight ratio of the high nickel matte powders to the acid leaching extraction solution is 1:1 to 1:15;
maintaining the acid leaching extraction reaction for 3 to 10 hours; and
filtering out a solid residue in the acid leaching extraction solution to obtain a nickel sulfate-containing filtrate.

2. The method for refining nickel sulfate at a normal pressure according to claim 1, wherein the acid etching agent is selected from the group consisting of hydrochloric acid, nitric acid, chromic acid, perchloric acid, hypochlorous acid, citric acid, oxalic acid and acetic acid.

3. The method for refining nickel sulfate at a normal pressure according to claim 1, wherein the surfactant comprises a sulfonate (SO₃⁻), and has the molecular weight of 150 to 300.

4. The method for refining nickel sulfate at a normal pressure according to claim 3, wherein the surfactant is selected from the group consisting of 4-methyl benzenesulfonic acid, dodecane-1-sulfonic acid sodium, 4-aminotoluene-3-sulfonic acid, 2,5-dimethylbenzenesulfonic acid, a 2-naphthol-6-sulfonic acid potassium salt, 4-hydroxybenzenesulfonic acid, sulfanilic acid, sodium 4-vinylbenzenesulfonate, 3-amino-4-hydroxybenzenesulfonic acid, 4-amino-1-naphthalenesulfonic acid, 8-amino-2-naphthalenesulfonic acid, 7-amino-4-hydroxy-2-naphthalenesulfonic acid, a 2-formylbenzenesulfonic acid sodium salt, a 4-amino-1-naphthalenesulfonic acid sodium salt, a benzenethionosulfonic acid sodium salt, a 3-(trimethylsilyl)-1-propanesulfonic acid sodium salt, 3-amino-4-methoxybenzenesulfonic acid, 5-amino-2-naphthalenesulfonic acid and sodium 2-naphthalenesulfonate.

5. The method for refining nickel sulfate at a normal pressure according to claim 1, wherein the auxiliary agent accounts for 0.5 to 6 wt % of the nickel extractant.

6. The method for refining nickel sulfate at a normal pressure according to claim 1, wherein the temperature of the acid leaching extraction reaction is 20 to 60° C., and the pH value is 0.5 to 4.

7. The method for refining nickel sulfate at a normal pressure according to claim 1, wherein stirring is maintained at a speed of 200 to 800 RPM during the acid leaching extraction reaction.

8. The method for refining nickel sulfate at a normal pressure according to claim 1, wherein the concentration of the sulfuric acid solution is 30 to 60 vol %.

9. The method for refining nickel sulfate at a normal pressure according to claim 1, wherein the particle sizes of the high nickel matte powders are 100 μm to 200 μm.

10. The method for refining nickel sulfate at a normal pressure according to claim 1, wherein the solid-liquid weight ratio of the high nickel matte powders to the acid leaching extraction solution is 1:4 to 1:6.

11. The method for refining nickel sulfate at a normal pressure according to claim 1, wherein the inorganic salt is selected from the group consisting of sodium salts, ammonium salts, aluminum salts, copper salts and iron salts of sulfuric acid, nitric acid, nitrous acid, phosphoric acid and carbonic acid.

12. The method for refining nickel sulfate at a normal pressure according to claim 1, wherein the organic salt is selected from the group consisting of sodium salts, ammonium salts, aluminum salts, copper salts and iron salts of citric acid, oxalic acid, acetic acid, succinic acid and gluconic acid.

13. The method for refining nickel sulfate at a normal pressure according to claim 1, further comprising:
neutralizing the nickel sulfate-containing filtrate, adding a precipitant, and filtering out a precipitate;
removing an acid etching agent by-product and the surfactant in the nickel sulfate-containing filtrate to obtain a nickel sulfate solution; and
removing water in the nickel sulfate solution to obtain a solid nickel sulfate.

14. A nickel extractant, comprising:
an acid etching agent accounting for at least 40 wt %;
pure water accounting for 50 to 60 wt %; and
an auxiliary agent selected from the group consisting of a surfactant, an organic salt and an inorganic salt, and amounting for 0.1 to 10 wt %.

15. The nickel extractant according to claim 14, wherein the acid etching agent is selected from the group consisting of hydrochloric acid, nitric acid, chromic acid, perchloric acid, hypochlorous acid, citric acid, oxalic acid and acetic acid.

16. The nickel extractant according to claim 14, wherein the surfactant comprises a sulfonate (SO3−), and has the molecular weight of 150 to 300.

17. The nickel extractant according to claim 16, wherein the surfactant is selected from the group consisting of 4-methyl benzenesulfonic acid, dodecane-1-sulfonic acid sodium, 4-aminotoluene-3-sulfonic acid, 2,5-dimethylbenzenesulfonic acid, a 2-naphthol-6-sulfonic acid acid, sodium 4-potassium salt, 4-hydroxybenzenesulfonic acid, sulfanilic vinylbenzenesulfonate, 3-amino-4-hydroxybenzenesulfonic acid, 4-amino-1-naphthalenesulfonic acid, 8-amino-2-naphthalenesulfonic acid, 7-amino-4-hydroxy-2-naphthalenesulfonic acid, a 2-formylbenzenesulfonic acid sodium salt, a 4-amino-1-naphthalenesulfonic acid sodium salt, a benzenethionosulfonic acid sodium salt, a 3-(trimethylsilyl)-1-propanesulfonic acid sodium salt, 3-amino-4-methoxybenzenesulfonic acid, 5-amino-2-naphthalenesulfonic acid and sodium 2-naphthalenesulfonate.

18. The nickel extractant according to claim 14, wherein the auxiliary agent accounts for 0.5 to 6 wt %.

19. The nickel extractant according to claim 14, wherein the inorganic salt is selected from the group consisting of sodium salts, ammonium salts, aluminum salts, copper salts and iron salts of sulfuric acid, nitric acid, nitrous acid, carbonic acid and phosphoric acid.

20. The nickel extractant according to claim 14, wherein the organic salt is selected from the group consisting of sodium salts, ammonium salts, aluminum salts, copper salts and iron salts of citric acid, oxalic acid, acetic acid, succinic acid and gluconic acid.
